(19) United States
(12) Patent Application Publication
(10) Pub. No.: US 2021/0295219 A1
(43) Pub. Date: Sep. 23, 2021

(54) ACCOMMODATION AREA MANAGEMENT DEVICE

(71) Applicant: HONDA MOTOR CO., LTD., Tokyo (JP)

(72) Inventors: Gaku SHIMAMOTO, Saitama (JP); Junpei NOGUCHI, Saitama (JP); Yuta TAKADA, Tokyo (JP); Ryoma TAGUCHI, Tokyo (JP); Shogo KOBAYASHI, Saitama (JP)

(73) Assignee: HONDA MOTOR CO., LTD., Tokyo (JP)

(21) Appl. No.: 17/204,349

(22) Filed: Mar. 17, 2021

(30) Foreign Application Priority Data
Mar. 19, 2020 (JP) 2020-050295

(51) Int. Cl. G06Q 10/02; G06Q 10/00

(52) U.S. Cl. CPC G06Q 10/02; B60S 5/04; G06Q 10/20

(57) ABSTRACT

A parking lot management device which manages a parking lot includes an acquisition unit and a parking management unit. The acquisition unit acquires stop reservation information regarding a reservation for stopping a vehicle in the parking lot from a terminal device of a user of the vehicle or the vehicle. The parking management unit sets one of the plurality of parking spaces as a parking space for stopping the vehicle according to the scheduled stop time of the vehicle in the parking lot based on the stop reservation information acquired by the acquisition unit. The parking lot is divided into a plurality of parking areas, each having one or more accommodation positions, and the parking management unit sets an accommodation position included in the parking areas corresponding to the scheduled stop time among the plurality of parking areas as an accommodation position for stopping the vehicle.

### CROSS-REFERENCE TO RELATED APPLICATIONS

The present application claims the benefit of priority of Japanese Patent Application No. 2020-050295, filed on Mar. 19, 2020, the content of which is incorporated herein by reference.

### TECHNICAL FIELD

The present invention relates to an accommodation area management device which manages an accommodation area capable of accommodating a moving body.

### BACKGROUND

In recent year, a technique related to reservation management of a parking lot is disclosed in which when a user requests a reservation, it is determined whether the reservation can be accepted, and when it is determined that the reservation cannot be accepted, another user is urged to make a vehicle exit from a parking lot, and further when it is approved to make the vehicle exit, the reservation is executed (see, for example, JP-A-2012-215923).

### SUMMARY

However, in the technique of the related art, a technique which appropriately manages an accommodation position of a moving body such as a vehicle within a predetermined accommodation area such as a parking lot has not been sufficiently studied. Specifically, no study has been made on managing the accommodation position of the moving body in consideration of a scheduled stop time of the moving body in the accommodation area, and there is room for improvement in this respect.

The present embodiment provides an accommodation area management device which enables appropriate management of the accommodation position of the moving body in the accommodation area in consideration of the scheduled stop time of the moving body.

An aspect of the present embodiment is an accommodation area management device which manages an accommodation area that accommodates a moving body and stops the moving body at one of a plurality of accommodation positions provided in the accommodation area, the device comprising:

an acquisition unit which acquires stop reservation information regarding a reservation for stopping the moving body in the accommodation area from a terminal device of a user of the moving body or the moving body; and

a stop management which sets one of the plurality of accommodation positions as an accommodation position for stopping the moving body according to the scheduled stop time of the moving body in the accommodation area based on the stop reservation information acquired by the acquisition unit, wherein

the accommodation area is divided into a plurality of partial accommodation areas, each having one or more accommodation positions, and

the stop management unit sets an accommodation position included in the partial accommodation area corresponding to the scheduled stop time among the plurality of partial accommodation areas as an accommodation position for stopping the moving body.

According to the present embodiment, it is possible to appropriately manage the accommodation position of the moving body in the accommodation area in consideration of the scheduled stop time of the moving body.

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device.

FIG. 3 is a diagram illustrating an example of a configuration of the parking lot management device.

FIG. 4 is a diagram illustrating an example of a parking reservation table.

FIG. 5 is a diagram illustrating an example of a parking space status table.

FIG. 6 is a diagram illustrating an example of a state in which the allocation of a parking area is changed from the state of FIG. 2.

FIG. 7 is a flow chart illustrating a flow of a series of processes of a parking lot management device.

### DESCRIPTION OF EMBODIMENTS

Hereinafter, an embodiment of an accommodation area management device of the present invention will be described with reference to the accompanying drawings. In the following embodiment, an example will be described in which a moving body in the present invention is a vehicle and an accommodation area in the present invention is a parking lot. Further, in the following embodiment, an example in which the accommodation area management device of the present invention is used as a parking lot management device for managing a parking lot will be described.

### Vehicle System

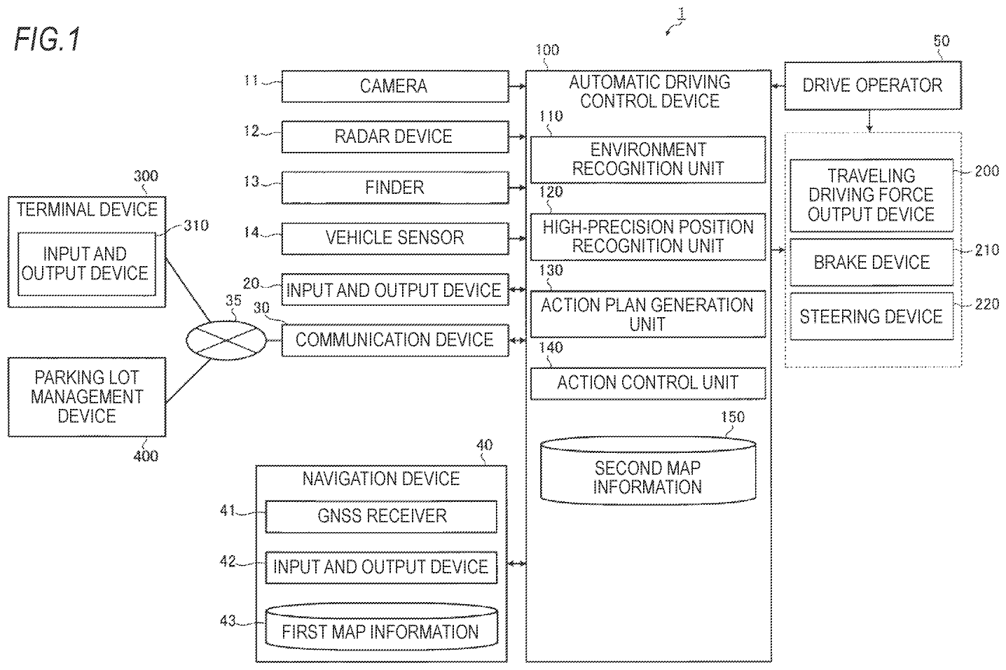

First, a vehicle of the embodiment will be described. In FIG. 1, a vehicle system 1 is mounted on a vehicle having an automatic driving function of a so-called automatic driving level “4” or higher. A vehicle (hereinafter, also referred to as vehicle M) equipped with the vehicle system 1 is a vehicle including a drive source (for example, traveling driving force output device 200 described below) and wheels (for example, two wheels, three wheels, or four wheels) including driving wheels driven by the power of the drive source. The drive source of the vehicle M is, for example, an electric motor. Further, the drive source of the vehicle M may be an internal combustion engine such as a gasoline engine or a combination of an electric motor and an internal combustion engine.

As illustrated in FIG. 1, the vehicle system 1 includes a camera 11, a radar device 12, a finder 13, a vehicle sensor 14, an input and output device 20, a communication device 30, a navigation device 40, a drive operator 50, an automatic driving control device 100, the traveling driving force output device 200, a brake device 210, and a steering device 220. Each of those devices is communicably connected to each other by a wired or wireless communication network. The communication network connecting each of those devices is, for example, Controller Area Network (CAN).

The camera 11 is a digital camera which photographs the periphery (for example, in front of vehicle M) of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of vehicle M) of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication intensity) of the radio wave used by the communication device 30 described later, for communication. The vehicle sensor 14 outputs the detection result of each sensor to the automatic driving control device 100 or the like.

The input and output device 20 includes an output device which outputs various kinds of information to a user of the vehicle M and an input device which accepts various input operations from the user of the vehicle M. The output device of the input and output device 20 is, for example, a display which displays based on a processing result of the automatic driving control device 100. The output device may be a speaker, a buzzer, an indicator light, or the like. Further, the input device of the input and output device 20 is, for example, a touch panel or an operation button (key, switch, or the like) which outputs an operation signal corresponding to an input operation received from a user to the automatic driving control device 100.

The communication device 30 is connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carded by a user of the vehicle M, a parking lot management device 400 which manages a parking lot PA where the vehicle M can be parked. The terminal device 300 is, for example, a smartphone or a tablet terminal and is an electronic device connected to the network 35 and including an input and output device 310. The input and output device 310 is, for example, a display which displays various information to a user, a touch panel which accepts a user's input operation, and the like. The parking lot PA and the parking lot management device 400 will be described below.

The navigation device 40 includes a Global Navigation Satellite System (GLASS) receiver 41 and an input and output device 42. Further, the navigation device 40 includes a storage device (not illustrated) such as a flash memory, and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user of the vehicle M and an input device which accepts various input operations from a user of the vehicle M. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

For example, the navigation device 40 determines a route (hereinafter, also referred to as a route on the map) from the position of the vehicle M specified by the GNSS receiver 41 to a destination input by the user with reference to the first map information 43. Then, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by the function of the terminal device 300. Also, for example, the communication device 30 may transmit information indicating the position of the vehicle M and the destination input by a user to a server device (navigation server) outside the vehicle system 1, and the function of the navigation device 40 may be realized by this server device.

The drive operator 50 includes operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction of the steering wheels.

### Automatic Driving Control Device

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and a second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from the parking lot management device 400. Then, the automatic driving control device 100 updates the second map information 150 so as to incorporate the received in-parking-lot map information into the second map information 150. As a result, the automatic driving control device 100 can specify the position of each parking space in the parking lot PA with reference to the second map information 150.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processing Unit (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processing Unit (GPU), and for example, the storage device for storing the second map information 150 and the high-precision position recognition unit 120 may be realized by a Map Positioning Unit (MPU). Further, a part or all of the functional units of the automatic driving control device 100 may be realized by the cooperation of software and hardware.

### Parking Lot Managed by Parking Lot Management Device

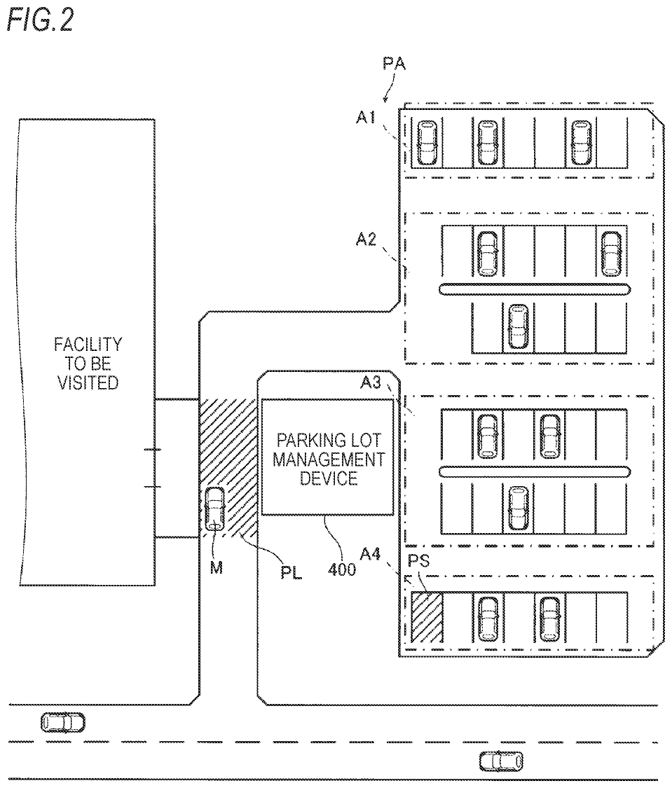

Next, an example of the parking lot PA will be described with reference to FIG. 2. As illustrated in FIG. 2, the parking lot PA is a parking lot managed by the parking lot management device 400, and is an automatic valet parking type parking lot attached to a visited facility to be visited by a user. The parking lot PA includes a plurality of parking spaces PS where a vehicle (for example, vehicle M) can be accommodated and a platform PL provided right before the plurality of parking spaces PS. Hereinafter, an example in which a user of the vehicle M uses the parking lot PA will be described.

Before using the parking lot PA, the user of the vehicle M makes a reservation (hereinafter, also referred to as a parking reservation) for using the parking lot PA with respect to the parking lot management device 400 that manages the parking lot PA by using the terminal device 300. In the parking reservation, the user of the vehicle M inputs a vehicle ID, which is the identification information of the vehicle M to be parked in the parking lot PA, and a reservation time zone in which the vehicle M is scheduled to be parked in the parking lot PA, into the terminal device 300 or the like. Here, the reservation time zone represents a time zone from a scheduled entry date and time to the parking lot PA, to a scheduled exit date and time from the parking lot PA, for example. The above information input by the user in the parking reservation is transmitted to the parking lot management device 400 as parking reservation information, and stored by the parking lot management device 400. After that, at the reserved date and time, the user of the vehicle M rides the vehicle M on the platform PL and gets off from the vehicle M at the platform PL.

After the user gets off the vehicle M, the vehicle M automatically drives and starts a self-propelled parking event to move to the parking space PS in the parking lot PA. For example, the user uses the terminal device 300 to send a request to start the self-propelled parking event to move to the parking space PS to the parking lot management device 400. In response to this start request, the parking lot management device 400 instructs the vehicle M to perform the self-propelled parking event for parking the vehicle M in a predetermined parking space PS. According to this instruction, the vehicle M moves to the parking space PS instructed by the parking lot management device 400 while being guided by the parking lot management device 400 or sensing with the camera 11, the radar device 12, the finder 13, or the like.

In addition, the vehicle M can carry out re-parking again, so-called “reparking”, in which the parking position is changed to another parking position while the vehicle M is parked in the parking lot PA. The reparking is appropriately carried out by an instruction from the parking lot management device 400 or by voluntary automatic driving by the vehicle M itself.

In addition, at the time of exiting from the parking lot PA, the vehicle M performs automatic driving and performs a self-propelled parking event to move from the parking space PS to the platform PL. For example, the user uses the terminal device 300 to send a request to start the self-propelled parking event for moving the vehicle M to the platform PL to the parking lot management device 400. In response to this start request, the parking lot management device 400 instructs the vehicle M to perform the self-propelled parking event for moving the vehicle M from the parking space PS where the vehicle M is parked to the platform PL. According to this instruction, the vehicle M moves to the platform PL while being guided by the parking lot management device 400 or sensing with the camera 11, the radar device 12, the finder 13, or the like. The user of the vehicle M gets on the vehicle M at the platform PL and exits from the parking lot PA.

### Parking Lot Management Device

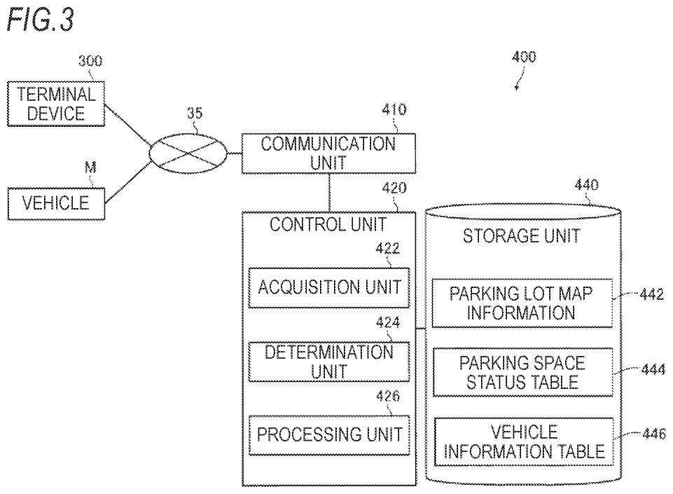

Next, an example of the configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, a parking management unit 424, and a processing unit 426. Each component of the control unit 420 is realized, for example, by a hardware processor such as a CPU executing a program (software). Some or all of those components may be realized by hardware (circuit part: including circuitry) such as LSI, ASIC, FPGA, and GPU or may be realized by collaboration between software and hardware. The program may be stored in advance in a storage device (a storage device including a non-transient storage medium) such as an HDD or a flash memory, or the program may be stored in a removable storage medium (a non-transient storage medium) such as a DVD or a CD-ROM and installed by attaching the storage medium to a drive device.

Information such as parking lot map information 442, parking reservation table 444, and parking space status table 446 is stored in the storage unit 440. The storage unit 440 is realized by an HDD, a flash memory, or the like.

The communication unit 410 communicates with the vehicle M or the user's terminal device 300 wirelessly (for example, network 35). The control unit 420 determines the parking space PS for parking the vehicle M based on the information acquired by the communication unit 410 and the information stored in the storage unit 440, and guides the vehicle M to the parking space PS. The parking lot map information 442 is information which geometrically represents the structure of the parking lot PA. Further, the parking lot map information 442 includes the coordinates for each parking space PS.

The acquisition unit 422 acquires parking reservation information from the terminal device 300 or the like owned by the user via the communication unit 410. The parking reservation information is an example of stop reservation information in the present invention, and is information related to a reservation for parking the vehicle M in the parking lot PA. As described above, the parking reservation information includes, for example, information indicating a vehicle ID which is identification information of the vehicle M to be parked in the parking lot PA. and a reservation time zone in which the vehicle M is scheduled to be parked in the parking lot PA. The parking reservation information acquired by the acquisition unit 422 is stored in the parking reservation table 444, for example.

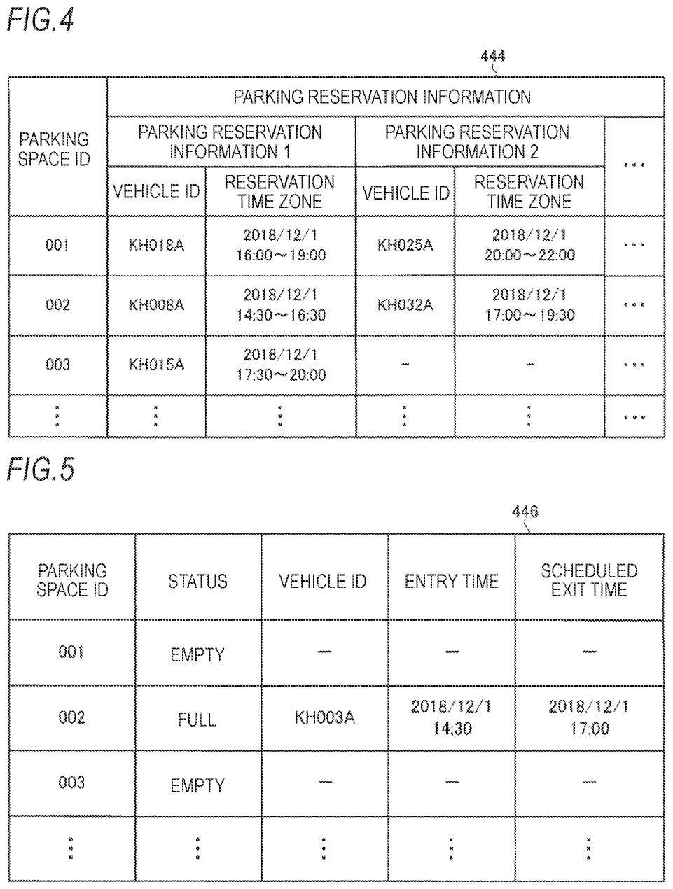

As shown in FIG. 4, the parking reservation table 444 stores, for example, the parking space ID which is the identification information of the parking space PS in association with the parking reservation information about the parking space PS of the parking space ID. In addition, the parking reservation table 444 may store, for example, a plurality of pieces of parking reservation information in association with the parking space ID.

In the example shown in FIG. 4, for a parking space PS with a parking space ID “001”, as the first parking reservation information (parking reservation information 1), information indicating a vehicle ID “KH018A” and the reservation time zone “2018 Dec. 1 16:00 to 19:00” is stored. This indicates that the vehicle M with the vehicle ID “KH018A” will be parked in the parking space PS with the parking space ID “001” during the reservation time zone “2018 Dec. 1 16:00 to 19:00”.

In addition, the parking lot management device 400 stores, for example, the parking reservation information received from the terminal device 300 or the like in association with the parking space ID of the parking space PS that can be parked (that is, parking space PS that is not used by the other vehicles M during the period included in the reservation time zone) in the reservation time zone indicated by the parking reservation information, in the parking reservation table 444.

Further, the parking lot management device 400 is configured to be able to accept an application for changing (for example, extending) the parking reservation, that is, an application for changing (for example, extending) the reservation time zone from a terminal device 300 or the like owned by the user via the communication unit 410, and update the parking reservation table 444 based on this application.

In the example shown in FIG. 4, for example, for a parking space PS with a parking space ID “003”, as the first parking reservation information (parking reservation information 1), information indicating a vehicle ID “KH015A” and the reservation time zone “2018/12/1 17:30 to 20:00” is stored. Then, for example, when an application for extending the reservation time zone to “2018/12/1 22:00” is accepted from the terminal device 300 of the user of the vehicle M with the vehicle ID “KH015A”, the parking lot management device 400 updates the parking reservation information 1 of the parking space PS of the parking space ID “003”. Specifically, the parking lot management device 400 stores information indicating the vehicle ID “KH015A” and the reservation time zone “2018/12/1 17:30 to 22:00” as the parking reservation information 1 of the parking space PS with the parking space ID “003” based on the accepted application for extension.

Further, the acquisition unit 422 can also acquire the position information of the vehicle M already parked in the parking lot PA via the communication unit 410. This position information is stored, for example, in the form of the parking space status table 446. As illustrated in FIG. 5, in the parking space status table 446, for example, information indicating whether the parking space PS is empty or full (parked), the vehicle ID which is the identification information of the parked vehicle M when the parking space PS is full, and the entry time and scheduled exit time of the vehicle M when the parking space PS is full, are associated with the parking space ID which is the identification information of the parking space PS. The entry time and the scheduled exit time are recorded, for example, in association with the vehicle ID of the vehicle M when the vehicle M enters the parking lot PA. The vehicle ID can be, for example, a vehicle number written on a vehicle number plate (so-called license plate).

In addition, the acquisition unit 422 can also acquire the position information of the vehicle M traveling in the parking lot PA. The vehicle M traveling in the parking lot PA periodically transmits information associating the vehicle ID of the own vehicle with the position (for example, the position recognized by high-precision position recognition unit 120) of the own vehicle in the parking lot PA, to the parking lot management device 400. The acquisition unit 422 acquires information in which the vehicle ID transmitted from the vehicle M traveling in the parking lot PA and the position in the parking lot PA are associated with each other via the communication unit 410. Further, when the parking lot management device 400 receives the information in which the vehicle ID and the position in the parking lot PA are associated with each other from the vehicle M traveling in the parking lot PA, the parking lot management device 400 may store the received information in a predetermined table of the storage unit 440. Then, the acquisition unit 422 may acquire the position information of the vehicle M traveling in the parking lot PA with reference to this table.

By the way, there are various purposes for the user to park the vehicle M in the parking lot PA, and the length of the reservation time zone, that is, the scheduled parking time (period) scheduled to be parked in the parking lot PA also varies according to the purpose. While some users have the vehicle M exit from the parking lot PA in a few hours, such as one hour, some users park the vehicle M in the parking lot PA for a long period of time such as one month.

Therefore, according to the embodiment, the parking lot management device 400 sets a parking space PS for parking the vehicle M according to the scheduled parking time of the vehicle M in the parking lot PA by the parking management unit 424. By this process, efficient use of the parking lot PA can be achieved. The parking management unit 424 is an example of the stop management unit in the present invention.

The above process will be described more specifically with reference to FIG. 2. In the embodiment, the parking lot PA is divided into four parking areas A1 to A4. Each of the parking areas A1 to A4 has one or more parking spaces PS. In addition, a parking time width corresponding to the length of the scheduled parking time is allocated to each of the parking areas A1 to A4.

For example, a vehicle M having a scheduled parking time of 1 to 3 hours is guided to be parked in the parking space PS included in the parking area A1 to A4. Likewise, a vehicle M having a scheduled parking time of 3 to 6 hours is guided to be parked in the parking space PS included in the parking area A2. Further, a vehicle M having a scheduled parking time of 6 to 12 hours is guided to be parked in the parking space PS included in the parking area A3. Then, a vehicle M having a scheduled parking time longer than 12 hours (for example, one month) is guided to be parked in the parking space PS included in the parking area A4.

That is, the parking management unit 424 determines a parking space PS included in any of the parking areas A1 to A4 to park the vehicle M, according to the scheduled parking time of each vehicle M to be parked in the parking lot PA. For example, when the scheduled parking time of a certain vehicle M is 1 to 3 hours, the parking management unit 424 determines the parking space PS to park the vehicle M to be a parking space PS included in the parking area A1 and a parking space PS in which another vehicle M is not parked.

By the process described above, the parking lot management device 400 can park each vehicle M in the parking lot PA at a parking position (parking space PS) determined according to the scheduled parking time of the vehicle M. Therefore, in the parking lot PA, the vehicles M having scheduled parking times close to each other can be collectively parked, and it is thus possible to efficiently operate the parking lot PA.

Further, the parking management unit 424 may determine in advance the parking position of the vehicle M scheduled to be parked in the parking lot PA in the future, according to the scheduled parking time of the vehicle M, before the vehicle M enters the parking lot PA. For example, it is assumed that the scheduled parking time of a certain vehicle M for which a parking reservation has been made is 1 to 3 hours. In this case, the parking management unit 424 may store the parking reservation information for the vehicle M in association with the parking space ID of the parking space PS included in the parking area A1 in the parking reservation table 444 to determine the parking position of the vehicle M in advance.

Further, when the scheduled parking time of a certain vehicle M parked in the parking lot PA is changed, the parking management unit 424 may reset the parking space PS included in the parking area corresponding to the changed scheduled parking time as the parking space PS for parking the vehicle M and move the vehicle M to the parking space PS. For example, the user of the vehicle M may instruct the parking lot management device 400 to change the scheduled parking time of the parked vehicle M from 2 hours to 5 hours (that is, extension in this case) by using the terminal device 300 or the like.

In such a case, the parking management unit 424 moves (that is, reparks) the vehicle M of which the scheduled parking time has been extended, from the parking space PS in the parking area A1 to the parking space PS in the parking area A2. As a result, even when the scheduled parking time of the parked vehicle M is changed, the vehicle M can be parked at an appropriate position, and the parking lot PA can be used more effectively.

In addition, there are situations when the obstacles such as road cones that hinder parking (hereinafter, also referred to as parking obstacles) are in the parking space PS at the repark destination, such that the vehicle M to be reparked cannot be parked in the parking space PS at the repark destination. In such a case, the parking management unit 424 may reset the parking position of the vehicle M to be reparked to the parking space PS where it was parked before the repark or to a predetermined parking space PS predetermined as a temporary parking space PS. As a result, the parking lot PA can be utilized more effectively.

Further, the parking management unit 424 may move the vehicle M to a predetermined charging spot when the parking time of a vehicle M, for which charging is applied, in the parking lot PA exceeds a predetermined time. Here, the vehicle M for which charging is applied is a vehicle M of which a drive source is an electric motor that outputs power based on the electric power of a battery, for example. In addition, the charging spot is a parking space PS with a power feeding apparatus for supplying power to the vehicle M, for example.

That is, when the parking time is long and the remaining capacity of the battery of the vehicle M decreases due to natural discharge or the like, the vehicle M using the electric motor as a drive source may not be able to travel. Therefore, for a vehicle M that uses an electric motor as a drive source, that is, for the vehicle M for which charging is applied, when the parking time exceeds a predetermined time, the vehicle M is moved to the charging spot to supply power, and it is thus possible to recover the remaining capacity of the battery of the vehicle M and avoid being unable to travel.

Meanwhile, a vehicle M of which drive source is an internal combustion engine such as a gasoline engine can generally generate electricity by operating the internal combustion engine. Therefore, when the parking time of the vehicle M using the internal combustion engine as a drive source is long and the remaining capacity of the battery decreases, the internal combustion engine may be started to charge the battery without moving the vehicle M to the charging spot. As a result, the charging spot can be allocated only to the vehicle M that requires power supply from the charging spot, and the charging spot can be effectively utilized. Further, when charging the battery for the vehicle M using the internal combustion engine as the drive source, the parking lot management device 400 may allow the vehicle M to travel in the parking lot PA. Here, an example in which charging is used as an example of maintenance has been described, but the present invention is not limited thereto. For example, tire pressure also decreases over time. Therefore, for example, when the parking time of the vehicle M exceeds a predetermined time, the vehicle M may be moved to a maintenance spot where the tires can be filled with air.

Further, for example, the number of vehicles M having a specific scheduled parking time increases (or decreases) at a specific time zone, when a specific event occurs, or the like, and in some cases, the parking area allocation as shown in FIG. 2 may not be appropriate.

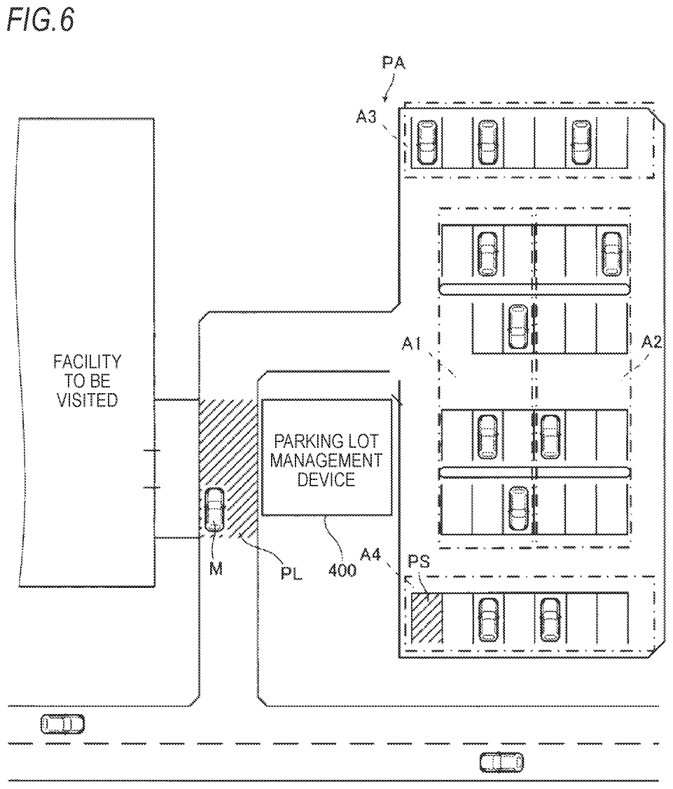

Therefore, the parking management unit 424 may change the positions of the parking areas A1, A2, and A3 to, for example, as shown in FIG. 6. For example, when the number of vehicles M with a scheduled parking time of 1 to 3 hours and vehicles M with a scheduled parking time of 3 to 6 hours increases, the positions of the parking areas A1 and A2 are moved to the vicinity of the center of the parking lot PA. As described above, the parking management unit 424 changes the distribution positions of the plurality of parking areas A1 to A4 to which different parking time widths are allocated in the parking lot PA. As a result, the distribution of the parking areas to which different parking time widths are allocated according to the reservation situation can be set appropriately, and the parking lot PA can be effectively utilized.

In addition, the parking management unit 424 may alternately arrange a first parking area to which the first parking time width is allocated and a second parking area to which the second parking time width longer than the first parking time width is allocated. As a result, since an area such as a parking area A1 (first parking area) where the vehicle M frequently enters and exits and a parking area A4 (second parking area) where the vehicle M enters and exits less frequently are arranged adjacent to each other, the route to the exit of the parking lot PA can be easily connected.

Further, when the scheduled parking time of a certain vehicle M is changed, the parking lot management device 400 may notify the terminal device 300 of the user of the vehicle M of a change indicating that the scheduled parking time has been changed. This change notification is an example of the re-notification in the present invention. As a result, the user can know that the scheduled parking time has been changed, which gives a sense of security.

Further, when the remaining time until the scheduled exit date and time of a certain vehicle M is less than a predetermined time, the parking lot management device 400 may notify the terminal device 300 of the user of that vehicle M to prompt the vehicle M to exit the parking lot PA or to change (extend) the scheduled parking time. As a result, it is possible to prompt the vehicle M, which is likely to exceed (or has exceeded) the scheduled parking time, to exit the parking lot and to change the scheduled parking time, thereby effectively utilizing the parking lot PA.

Further, within a predetermined time after the notification prompting to exit the parking lot or the notification prompting to change the scheduled parking time described above, when there is no application for exiting the parking lot PA of the vehicle M (for example, a request to start a self-propelled parking event to move to platform PL), or when there is no application to change the scheduled parking time of the vehicle M that triggered these notifications, the parking lot management device 400 may automatically change (extend) the scheduled parking time of the vehicle M. As a result, it possible to effectively utilize the parking lot PA.

Further, within a predetermined time after the notification prompting to exit the parking lot or the notification prompting to change the scheduled parking time described above, when there is no application for exiting the parking lot PA of the vehicle M (for example, a request to start a self-propelled parking event to move to platform PL), or when there is no application to change the scheduled parking time of the vehicle M that triggered these notifications, the parking lot management device 400 may move the vehicle M to a predetermined position. Here, the predetermined position can be the platform PL, for example. As a result, the vehicle M of which scheduled parking time is likely to be exceeded (or has been exceeded) can be removed from the parking space PS, and it is possible to effectively utilize the parking lot PA. Further, when a predetermined time elapses after moving the vehicle M to the predetermined position, the parking lot management device 400 returns (moves) the vehicle M to any parking space PS again, and the scheduled parking time of the vehicle M may be automatically changed (extended). By doing so, the vehicle M can be prevented from staying at a predetermined position for a long period of time and hindering other vehicles or the like, and it is possible to effectively utilize the parking lot PA.

The parking areas A1 to A4 shown in the embodiment are examples, and the number of these parking areas, the number of parking spaces included in these parking areas, the distribution position of these parking areas, and the like are not particularly limited, and may be set as appropriate.

When the parking space PS of the vehicle M is determined by the parking management unit 424, the processing unit 426 determines a suitable route to the parking space PS with reference to the parking lot map information 442, and transmits the route to the vehicle M using the communication unit 410.

In the vehicle M which receives the route, the action plan generation unit 130 generates a target track based on the route. The action control unit 140 controls the vehicle M to act according to the action plan generated by the action plan generation unit 130, and parks the vehicle M in the parking space PS.

### Processing Flow

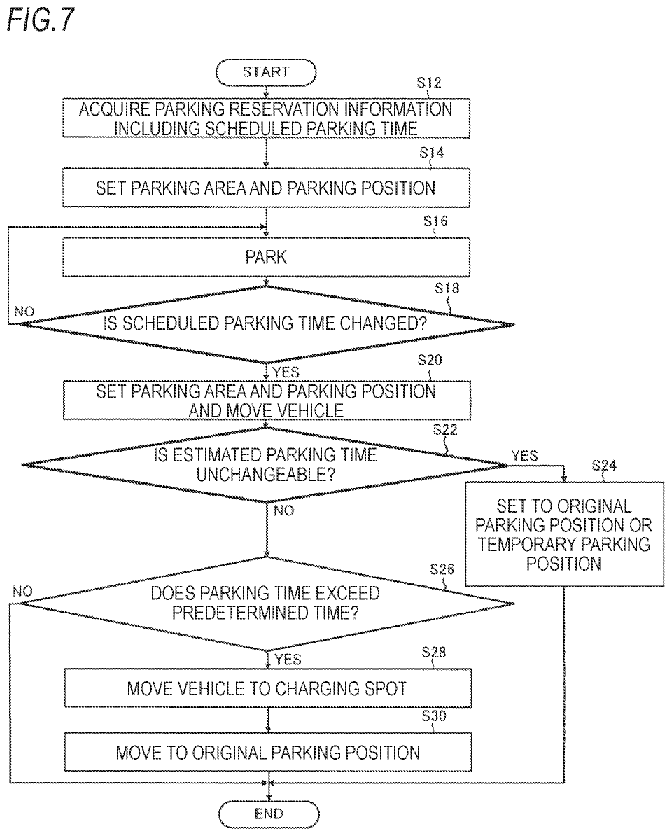

Hereinafter, a series of processing flows of the parking lot management device 400 will be described with reference to FIG. 7. The processes illustrated in FIG. 7 may be repeated at a predetermined cycle.

First, the acquisition unit 422 acquires parking reservation information including the scheduled parking time of the vehicle M scheduled to be parked in the parking lot PA or the vehicle M already parked in the parking lot PA via the communication unit 410 (Step S12). The acquisition unit 422 can acquire the parking reservation information and the scheduled parking time from the user's terminal device 300 or the parking reservation table 444 of the vehicle M. Then, the parking management unit 424 sets the parking area and thus the parking position in the parking area, of each vehicle M according to the acquired scheduled parking time (Step S14), and parks each vehicle M at the set parking position (Step S16).

Further, the parking management unit 424 confirms whether or not the scheduled parking time is changed, or specifically, confirms whether or not a request for changing the scheduled parking time is received from the user's terminal device 300, for the vehicle M already parked in the parking lot PA (Step S18). When this request is made (YES in Step S18), the parking management unit 424 resets the parking position of the vehicle M of which the scheduled parking time has been changed according to the changed scheduled parking time, and moves the vehicle M to the reset parking position (Step S20). However, in some cases, this movement may not be possible due to reasons such as the presence of a parking obstacle such as a road cone in the parking position after resetting, that is, in the parking space PS at the repark destination (YES in step S22). In this case, the parking management unit 424 sets the parking position of the vehicle M to be repacked to the original parking position before the reparking or to a temporary parking position other than the original parking position (Step S24).

Further, the parking management unit 424 determines whether or not the parking time of the vehicle M parked in the parking lot PA exceeds a predetermined time (Step S26), and when the parking time of the vehicle M for which charging is applied exceeds a predetermined time in particular (YES in Step S26), the parking management unit 424 moves the vehicle M to a predetermined charging spot and supplies power to the vehicle M (Step S28). Then, when charging is completed, the parking management unit 424 moves the vehicle M back to the original parking position (Step S30).

Further, in the middle of, or before and after the processing flow, the parking management unit 424 may appropriately change the distribution of the parking area as shown in FIGS. 2 and 6.

In the embodiment described above, the parking position is set according to the so-called parking time of the vehicle. However, the idea of the present invention is not limited to such an embodiment and is also applied to a moving body (for example, a robot) including a vehicle. That is, the present invention also includes a case where the target accommodation position is changed within the accommodation area for accommodating the so-called moving body. Under this idea, “parking” is extended to the concept of “stop” and the “parking lot management device” of the embodiment is extended to the concept of “accommodation area management device”. Further, since the “parking area” is an area that occupies a part of the parking lot which is the accommodation area, it is extended to the concept of “partial accommodation area”. The reparking also includes an operation of “re-stopping to change the accommodation position of the stopped moving body to another accommodation position within the accommodation area”.

Although the embodiment for carrying out the present invention is described above using the embodiment, the present invention is not limited to the embodiment and various modifications and substitutions can be made without departing from the gist of the present invention.

For example, in the embodiment described above, the example in which the scheduled parking time is extended has been described as the example in which the scheduled parking time is changed, but the present invention is not limited thereto. For example, the scheduled parking time may be shortened in response to a request from the user.

Further, in the embodiment described above, the example in which the parking reservation information is transmitted from the terminal device 300 to the parking lot management device 400 has been described, but the present invention is not limited thereto. The parking reservation information may be transmitted from the vehicle M to the parking lot management device 400. Specifically, in this case, the user of the vehicle M may input the vehicle ID and the reservation time zone to the vehicle M (for example, navigation device 40) by the input and output devices 20 and 42, and cause the input information to be transmitted from the vehicle M to the parking lot management device 400 as the parking reservation information.

In addition, at least the following matters are described in this specification. The components and the like corresponding to those of the embodiment described above are shown in parentheses, but the present invention is not limited thereto.

(1) An accommodation area management device (parking lot management device 400) which manages an accommodation area (parking lot PA) that accommodates a moving body (vehicle M) and stops the moving body at one of a plurality of accommodation positions (parking spaces PS) provided in the accommodation area, the device including:

an acquisition unit (acquisition unit 422) which acquires stop reservation information regarding a reservation for stopping the moving body in the accommodation area from a terminal device (terminal device 300) of a user of the moving body or the moving body; and

a stop management unit (parking management unit 424) which sets one of the plurality of accommodation positions as an accommodation position for stopping the moving body according to the scheduled stop time of the moving body in the accommodation area based on the stop reservation information acquired by the acquisition unit,

in which

the accommodation area is divided into a plurality of partial accommodation areas (parking areas A1 to A4), each having one or more accommodation positions, and

the stop management unit sets an accommodation position included in the partial accommodation area corresponding to the scheduled stop time among the plurality of partial accommodation areas as an accommodation position for stopping the moving body.

According to (1), the accommodation area is divided into a plurality of partial accommodation areas, each having one or more accommodation positions, and the stop management unit sets an accommodation position included in the partial accommodation area corresponding to the scheduled stop time of the moving body among plurality of partial accommodation areas as an accommodation position for stopping the moving body. For this reason, the moving bodies of which scheduled stop times are close to each other may be collectively stopped within the accommodation area, and it is possible to efficiently operate the accommodation area.

(2) The accommodation area management device according to (1), in which, when the scheduled stop time is changed, the stop management unit sets the accommodation position included in the partial accommodation area corresponding to the changed scheduled stop time as the accommodation position for stopping the moving body, and moves the moving body to the accommodation position.

According to (2), even when the scheduled stop time of the moving body is changed, the moving body can be stopped at an appropriate stop position according to the changed scheduled stop time.

(3) The accommodation area management device according to (2), in which,

when the moving body cannot be stopped at the accommodation position included in the partial accommodation area corresponding to the changed scheduled stop time, the stop management unit sets an original accommodation position where the moving body was stopped before moving to the accommodation position included in the partial accommodation area corresponding to the changed scheduled stop time or a temporary accommodation position other than the original accommodation position.

According to (3), even when the moving body cannot be stopped at the stop position according to the changed scheduled stop time for some reason, the moving body can be stopped at an appropriate stop position, such that it is possible to effectively utilize the accommodation area.

(4) The accommodation area management device according to any one of (1) to (3), in which

when the stop time in the accommodation area of the moving body to which maintenance is applied exceeds a predetermined time, the stop management unit moves the moving body to a predetermined maintenance spot.

According to (4), when the stop time of the moving body to which the maintenance is applied, is prolonged, the moving body is moved to the maintenance spot, so that the moving body can be maintained.

(5) The accommodation area management device according to any one of (1) to (4), in which

a stop time width is allocated to each of the plurality of partial accommodation areas according to the length of the scheduled stop time, and

the stop management unit changes the distribution position of the plurality of partial accommodation areas to which different stop time widths are allocated within the accommodation area.

According to (5), the distribution of the partial accommodation areas to which different stop time widths are allocated according to the reservation situation can be appropriately set, and the accommodation area can be effectively utilized.

(6) The accommodation area management device according to (5), in which

the stop management unit alternately arranges a first partial accommodation area to which a first stop time width is allocated and a second partial accommodation area to which a second stop time width longer than the first stop time width is allocated.

According to (6), it is possible to easily connect the route to the exit of the accommodation area.

(7) The accommodation area management device according to (2), in which,

when the remaining time until the scheduled exit date and time of the moving body in the accommodation area based on the stop reservation information is less than a predetermined time, the terminal device is notified to prompt the moving body to exit the accommodation area or to change the scheduled stop time.

According to (7), since it is possible to prompt the moving body to exit the accommodation area or change the scheduled stop time when the remaining time until the scheduled exit date and time is less than a predetermined time, effective use of the accommodation area can be achieved.

(8) The accommodation area management device according to (7), in which,

when the scheduled stop time of the moving body is changed, the terminal device is notified again that the scheduled stop time has been changed.

According to (8), it is possible to notify the user that the scheduled stop time has been changed, giving the user a sense of security.

(9) The accommodation area management device according to (7) or (8), in which,

when there is no application for the moving body to exit the accommodation area within a predetermined time after the notification prompting the moving body to exit the accommodation area, or when the user does not request to change the scheduled stop time within a predetermined time after the notification prompting the change of the scheduled stop time, the moving body is moved to a predetermined position.

According to (9), since the moving body which is likely to exceed (or has exceeded) the scheduled stop time is moved to a predetermined position, effective use of the accommodation area can be achieved.

(10) The accommodation area management device according to (7) or (8), in which,

when there is no application for the moving body to exit the accommodation area within a predetermined time after the notification prompting the moving body to exit the accommodation area, or when the user does not request to change the scheduled stop time within a predetermined time after the notification prompting the change of the scheduled stop time, the scheduled stop time is changed.

According to (10), since the scheduled stop time of the moving body which is likely to exceed (or has exceeded) the scheduled stop time is changed, effective use of the accommodation area can be achieved.

(11) The accommodation area management device according to (9), in which,

when a predetermined time elapses after moving the moving body to the predetermined position, the moving body is moved back to the accommodation area and the scheduled stop time is changed.

According to (11), when a predetermined time elapses after moving the moving body to the predetermined position, the moving body is moved back to the accommodation area and the scheduled stop time is changed such that effective use of the accommodation area can be achieved.

What is claimed is:

1. An accommodation area management device configured to manage an accommodation area that accommodates a moving body and configured to stop the moving body at one of a plurality of accommodation positions provided in the accommodation area, the device comprising:
an acquisition unit configured to acquire stop reservation information regarding a reservation for stopping the moving body in the accommodation area from a terminal device of a user of the moving body or the moving body; and
a stop management unit configured to set one of the plurality of accommodation positions as an accommodation position for stopping the moving body according to the scheduled stop time of the moving body in the accommodation area based on the stop reservation information acquired by the acquisition unit, wherein
the accommodation area is divided into a plurality of partial accommodation areas, each having one or more accommodation positions, and
the stop management unit sots an accommodation position included in the partial accommodation area corresponding to the scheduled stop time among the plurality of partial accommodation areas as an accommodation position for stopping the moving body.

2. The accommodation area management device according to claim 1, wherein,
when the scheduled stop time is changed, the stop management unit sets the accommodation position included in the partial accommodation area corresponding to the changed scheduled stop time as the accommodation position for stopping the moving body, and moves the moving body to the accommodation position.

3. The accommodation area management device according to claim 2, wherein,
when the moving body cannot be stopped at the accommodation position included in the partial accommodation area corresponding to the changed scheduled stop time, the stop management unit sets an original accommodation position where the moving body was stopped before moving to the accommodation position included in the partial accommodation area corresponding to the changed scheduled stop time or a temporary accommodation position other than the original accommodation position.

4. The accommodation area management device according to claim 1, wherein,
when the stop time in the accommodation area of the moving body to which maintenance is applied exceeds a predetermined time, the stop management unit moves the moving body to a predetermined maintenance spot.

5. The accommodation area management device according to claim 1, wherein
a stop time width is allocated to each of the plurality of partial accommodation areas according to the length of the scheduled stop time, and
the stop management unit changes the distribution position of the plurality of partial accommodation areas to which different stop time widths are allocated within the accommodation area.

6. The accommodation area management device according to claim 1, wherein
the stop management unit alternately arranges a first partial accommodation area to which a first stop time width is allocated and a second partial accommodation area to which a second stop time width longer than the first stop time width is allocated.

7. The accommodation area management device according to claim 2, wherein,
when the remaining time until the scheduled exit date and time of the moving body in the accommodation area based on the stop reservation information is less than a predetermined time, the terminal device is notified to prompt the moving body to exit the accommodation area or to change the scheduled stop time.

8. The accommodation area management device according to claim 7, wherein,
when the scheduled stop time of the moving body is changed, the terminal device is notified again that the scheduled stop time has been changed.

9. The accommodation area management device according to claim 7, wherein,
when there is no application for the moving body to exit the accommodation area within a predetermined time after the notification prompting the moving body to exit the accommodation area, or when the user does not request to change the scheduled stop time within a predetermined time after the notification prompting the change of the scheduled stop time, the moving body is moved to a predetermined position.

10. The accommodation area management device according to claim 7, wherein,
when there is no application for the moving body to exit the accommodation area within a predetermined time after the notification prompting the moving body to exit the accommodation area, or when the user does not request to change the scheduled stop time within a predetermined time after the notification prompting the change of the scheduled stop time, the scheduled stop time is changed.

11. The accommodation area management device according to claim 9, wherein,
when a predetermined time elapses after moving the moving body to the predetermined position, the moving body is moved back to the accommodation area and the scheduled stop time is changed.
